(19) United States
(12) Patent Application Publication
(10) Pub. No.: US 2015/0014143 A1
(43) Pub. Date: Jan. 15, 2015

(54) APPARATUS FOR HEAT-TREATING WASTE MATTERS

(71) Applicants: Sung Tae HONG, (US); Seong Jong YU, gimpo-si, Gyeonggi-do (KR)

(72) Inventors: Sung Tae Hong, Seoul (KR); Seong Jong Yu, Gimpo-si Yeonggi-do (KR)

(21) Appl. No.: 14/382,771

(22) PCT Filed: Oct. 24, 2012
(86) PCT No.: PCT/KR2012/008753

§ 371 Date: Sep. 4, 2014

(30) Foreign Application Priority Data
Mar. 5, 2012 (KR) 10-2012-0022554

(51) Int. Cl. B09B 3/00; C10B 57/18; B01D 47/02; C10B 57/14

(52) U.S. Cl. CPC B09B 3/0083; C10B 57/14; C10B 57/18; B01D 47/028
USPC 202/96

(57) ABSTRACT

The present invention relates to an apparatus for heat-treating waste matters, and more particularly an ecological apparatus for heat-treating waste matters, which enables waste matters such as various industrial wastes, city-living wastes and various high polymeric chemical wastes to be subjected to heat treatment at a lower temperature under vacuum in a heat-treating vessel without discharging pollutants produced during the heat treatment such as carbon, tar, noxious gases, malodors, and dust by treatment in a filter mechanism.

### TECHNICAL FIELD

The present invention relates to an apparatus for heat-treating waste matters, and more particularly an ecological apparatus for heat-treating waste matters, which enables waste matters such as various industrial wastes, city-living wastes and various high polymeric chemical wastes to be subjected to heat treatment at a lower temperature under vacuum in a heat-treating vessel without discharging pollutants produced during the heat treatment such as carbon, tar, noxious gases, malodors, and dust by treatment in a filter mechanism.

### BACKGROUND ART

A variety of wastes produced from industrial fields and homes contains a lot of water and emits malodor together with a variety of increased bacteria.

Such wastes are disposed in such a way that they are heaped at a predetermined place without being processed through a special disinfection and sterilization process and are transferred using a vehicle and are buried under ground or are discarded at sea or are incinerated.

In case that such wastes are heaped until they reach a predetermine amount for a predetermined period and are collected, malodor and leachate produced from the wastes during a heaping process or a collecting process may contaminate air or surrounding environments.

In case that such wastes are transferred to a predetermined burial place and are buried there, the leachate may penetrate into ground if the burial process is not cared well, which may contaminate soil, underground water or clean valley water.

Since an unlimited burial of wastes is impossible due to the limited burial places, so there is a great difficulty in treating wastes.

As a method for resolving such problems such as limited places, leachate and malodor, there is an incineration method.

Many kinds of incineration apparatuses designed to incinerate wastes are developed and used; however in case that wastes are incinerated, exhaust gases produced during an incineration process directly may emit into air without being specially precipitated.

The exhaust gases emitted into air during the incineration process or after the incineration may contain noxious substances such as dioxin which may seriously hurt living things such as plants and animals and may directly emit into air together with soot and smoke without being specially treated, thus causing serious contamination to surrounding environments. So, it seems that such an incineration method is not a basic resolution method.

### DISCLOSURE OF INVENTION

### Technical Problem

Accordingly, it is an object of the present invention to provide an apparatus for heat-treating waste matters which makes it possible to greatly inhibit the discharge of carbon dioxide when incinerating a variety of industrial wastes at a low temperature under a vacuum environment, while preventing a variety of other noxious gases from emitting into air.

It is another object of the present invention to provide an apparatus for heat-treating waste matters which may increase heat efficiency when incinerating wastes through a heat treatment, while easily disposing melted wastes.

It is further another object of the present invention to provide an apparatus for heat-treating waste matters which is configured to heat-treat together organic wastes and inorganic wastes without separating them from each other.

It is still further another object of the present invention to provide an apparatus for heat-treating waste matters which may increase a waste treatment capacity in such a way to uniformly heap wastes when inputting the wastes into the interior of a heat treatment unit, not heaping them at one side.

### Solution of Problem

To achieve the above objects, there is provided an apparatus for heat-treating waste matters which comprises a heat treatment unit configured to input a variety of industrial wastes into the interior and heat them at a low temperature under a vacuum environment, thus decomposing the wastes and collecting in solid states, and a filter unit configured to filter in the interior the noxious substances discharged in the course of the heat treatment of the wastes using a water membrane part and a vapor filtration filter part.

### Advantageous effects

As mentioned in the above, the apparatus for heat-treating waste matters has competitive advantages in decreasing work processes in such a way to heat-treat together organic wastes and inorganic wastes before treating the wastes, not separating them from each other.

Also, it is possible to expect a great economical effect since wastes may be used as a variety of energy resources since a high energy carbon-based compound such as waste vinyl or waste plastic may be heat-treated at a low temperature under a vacuum environment, not burying or incinerating them.

Also, it is possible to provide an ecological apparatus for heat-treating waste matters in such a way that noxious substances such as dioxin and soot and smoke is treated in the interior of a filter unit without filtering and emitting them into air since carbon is extracted during the heat treatment of wastes.

Also, the present invention makes it possible to greatly reduce the volume of wastes in such a way to heat-treat the wastes at a low temperature under a vacuum environment, and the carbon dissolved and extracted may be widely used as an industrial material in a variety of fields.

Also, the apparatus for heat-treating waste matters according to the present invention is easy to manufacture and install and may be manufactured into a variety of sizes. It may be installed on the spot where wastes are produced, thus performing heat treatment, so a moving distance necessary for the sake of waste treatment may be minimized.

### BRIEF DESCRIPTION OF DRAWINGS

FIG. 1 is a perspective view illustrating an engaged state of an apparatus for heat-treating waste matters according to the present invention.

FIG. 2 is a perspective view illustrating a disengaged state of an apparatus for heat-treating waste matters according to the present invention.

FIG. 3 is a cross sectional view illustrating an engaged state of an apparatus for heat-treating waste matters according to the present invention.

FIGS. 4A and 4B are perspective views illustrating a waste distributor of an apparatus for heat-treating waste matters according to the present invention.

FIG. 5 is a cross sectional view illustrating an engaged state so as to explain an operation state of a waste distributor of an apparatus for heat-treating waste matters according to the present invention.

FIG. 6 is an enlarged perspective view illustrating a heat blocking part of an apparatus for heat-treating waste matters according to the present invention.

FIGS. 7A and 7B are exemplary views illustrating a filter unit of an apparatus for heat-treating waste matters according to the present invention.

FIG. 8 is a cross sectional view illustrating an apparatus for heat-treating waste matters according to another exemplary embodiment of the present invention.

FIG. 9 is an enlarged perspective view schematically illustrating an apparatus for heat-treating waste matters according to another exemplary embodiment of the present invention.

FIG. 10 is a cross sectional view illustrating an apparatus for heat-treating waste matters according to another exemplary embodiment of the present invention.

FIG. 11 is a cross sectional view illustrating an operation state of an apparatus for heat-treating waste matters of FIG. 10.

FIG. 12 is a perspective view illustrating an apparatus for heat-treating waste matters of FIG. 10.

<Legends of Key Elements of the Drawings>

| | | |
|---|---|---|
| 1: waste heat treatment apparatus | 2: filter unit | 3: outer box |

| | | |
|---|---|---|
| 4: inner box | 5: insulation material layer | 6: punched hole mesh |

| 7: electric heater | 8: supply door | 9: discharge door |
|---|---|---|
| 10: door frame | 11: waste distributor | 12: distribution cover |
| 13: roller cover | 14: support rack | 15: roller |
| 16: driving shaft | 17: rotation motor | 18: shaft |
| 19: support pillar | 20, 20′: inner and outer tubes | |
| 21: prop | 22: roller groove part | 23: gasket |

| | | |
|---|---|---|
| 24: pulling motor | 25: vertical frame | 26: wire |
| 27: rotation protrusion | 28: inner frame | 29: outer frame |

| | | |
|---|---|---|
| 30: insertion groove | 31: insertion protrusion | 32: heat discharge tube |

| | | |
|---|---|---|
| 33: water spray box | 34: water membrane filter part | 35: vapor filtration filter part |

| | | |
|---|---|---|
| 36: wire mesh | 37: water distributor | 38: partition |
| 39: vapor filter | 40: dscharge hole | 41: water tank |

| | | |
|---|---|---|
| 42: underwater pump | 43: cooling water supply tube | 44: water discharge tube |

| | | |
|---|---|---|
| 45: tar discharge tube | 46: distribution screw | 47: weight detection sensor |

| | | |
|---|---|---|
| 48: controller | 49: dust input prevention shoulder | 50: drawer door |

| | | |
|---|---|---|
| 51: drawer | 52: cylinder | 53: height adjustment insertion groove |

| | | |
|---|---|---|
| 54: waste | 55: heat treatment unit | 56: heat adjusting set |

| | | |
|---|---|---|
| 57: rotary shaft | 58: angle | 59: water |

| | |
|---|---|
| 60: tar | 61: carbon |

### BEST MODES FOR CARRYING OUT THE INVENTION

The present invention will be described with reference to the accompany drawings in an effort to achieve the objects and effects of the present invention.

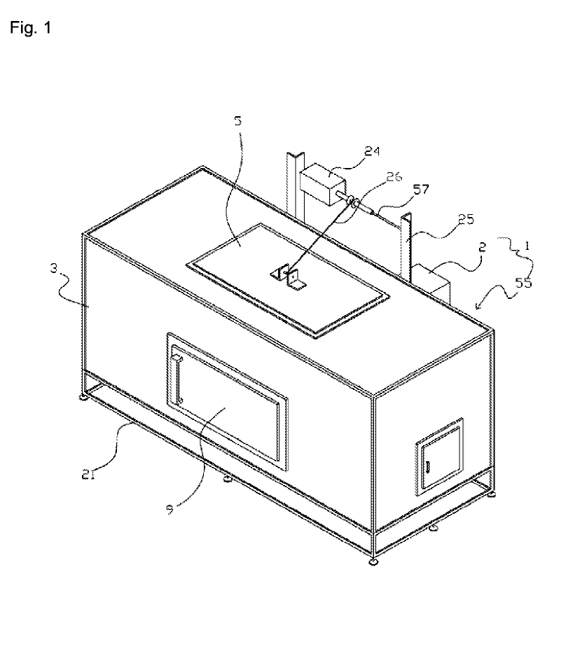

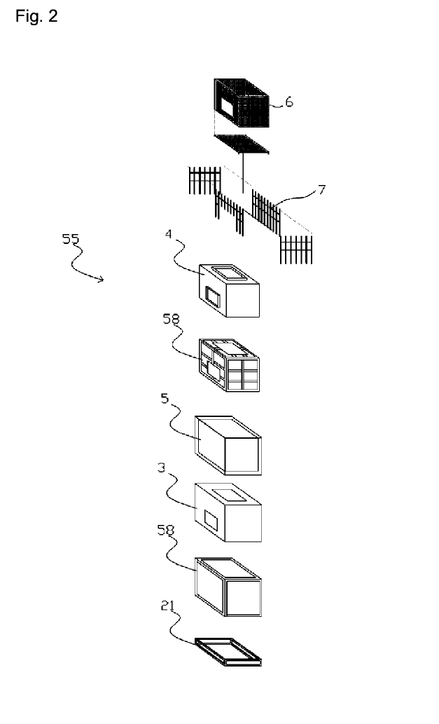

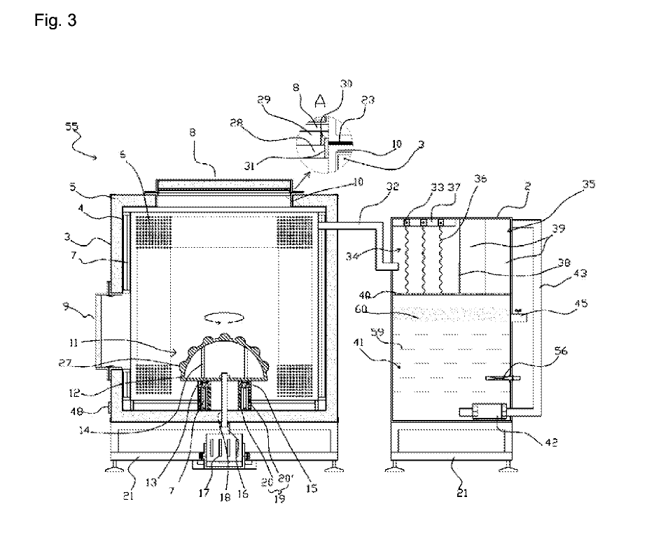

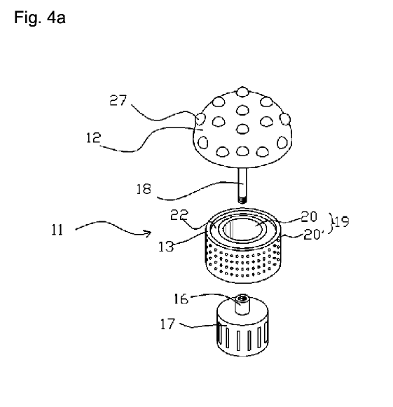

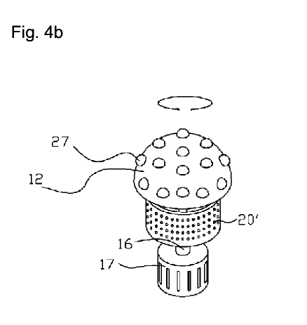

FIG. 1 is a perspective view illustrating an engaged state of an apparatus for heat-treating waste matters according to the present invention. FIG. 2 is a perspective view illustrating a disengaged state of an apparatus for heat-treating waste matters according to the present invention. FIG. 3 is a cross sectional view illustrating an engaged state of an apparatus for heat-treating waste matters according to the present invention. FIGS. 4A and 4B are perspective views illustrating a waste distributor of an apparatus for heat-treating waste matters according to the present invention.

The waste heat treatment apparatus 1 according to the present invention comprises a heat treatment unit 55 configured to heat-treat a variety of wastes 54 produced from industrial fields or homes at a temperature of below 200˜400° C. under a vacuum environment and perform a filtration in order for is noxious substances not to be discharged into air, while the remaining wastes 54 in the state of carbon 61 and tar 60 are collected and used as industrial materials.

The heat treatment unit 55 comprises a box-shaped outer box 3 with a prop 21 at its bottom wherein the outer box 3 comprises on its upper surface a supply door 8 through which the wastes 54 are inputted for heat-treating the wastes 54 at a low temperature under a vacuum environment, a discharge door 9 disposed on its front surface and side surface for discharging the wastes 54 which are decomposed into carbons, and a controller 48 disposed at one side of an outer circumferential surface for controlling an electric heater 7 and a waste distributor 11.

In order to maintain a vacuum state in the interior of the heat treatment unit 55, there are provided a supply door 8 and a discharge door 9 for supplying and discharging the wastes 54, and a door frame 10. A gasket 23 is disposed between them for the sake of tight sealing.

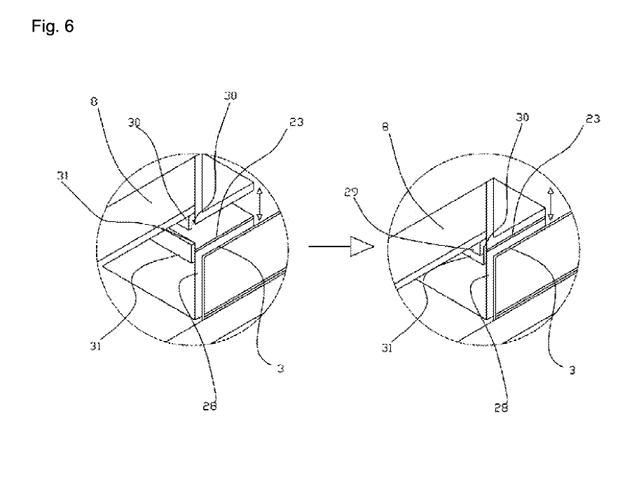

As illustrated in FIG. 6, the present invention is characterized in that a door frame 10 is fixedly inserted into part of the outer box 3 where the supply door 8 and the discharge door 9 are installed for blocking heat so as to prevent any deformation when the gasket 23 comes into directed contact with the heat and protecting the gasket 23, and an inner frame 28 is attached to a surrounding inner circumferential surface of the door frame 10, and an end of the inner frame 28 becomes an insertion protrusion 31 which is inserted in an insertion groove 30 formed in the outer frame 29 attached to the supply door 8 and the discharge door 9.

More specifically, the insertion protrusion 31 of the outer frame 29 attached to the door frame 10 is inserted into and departed from the insertion groove 30 of the outer frame 29 on the surrounding inner circumferential surfaces of the supply door 8 and the discharge door 9 so that the insertion protrusion 31 of the outer frame 29 attached to the door frame 10 may be inserted when the supply door 8 and the discharge door 9 are closed.

When the supply door 8 and the discharge door 9 are closed, heat produced from the electric heater 7 is prevented from coming into direct contact in such a way to cover so that the gasket 23 is not exposed to the interior of the outer box 3, thus improving durability.

It is preferred that the inner and outer frames 28 and 29 are made from an insulation material and a fireproof material in order to prevent heat from directly conducting to the gasket 23.

The inner frame 28 with an integrated insertion protrusion 31 is attached to the door frame 10 so as to make installation work easier in such a way that an end of one side of the gasket 23 comes into close contact with the insertion protrusion 31 and is supported when the gasket 23 is disposed. Also, it is to prevent any deformation at a portion between the supply door 8 and the discharge door 9 and the door frame 10 by means of pressure when the interior of the inner box 4 expands by means of heat.

An insulation material layer 5 is disposed in the interior of the outer box 3 so as to seal using an insulation material except for the portions of the supply door 8 and the discharge door 9. An insulation material is also disposed in the interiors of the supply door 8 and the discharge door 9 so as to prevent inner heat from emitting to the outside.

On an inner circumferential surface of the insulation material layer 5, there is provided an inner box 4 on an outer side of which a heat discharge tube 32 is provided so as to supply heat produced when supplying the wastes 54 through the supply door 8 and the discharge door 9 into the interior and decomposing the supplied wastes 54 by means of heat treatment and heat-treating the wastes 54, wherein it is made from stainless material in order to prevent any corrosion.

An electric heater 7 configured to heat the wastes 54 in a state that it is electrically connected is installed at a regular interval in a rod shape on a front side, a back side, a left side and a right side of the inner circumferential surface of the inner box 4 except for the portions where the discharge door 9 is installed are configured in a rod shape so as to heat the wastes 54 at a low temperature.

As not illustrated in the drawings, the electric heater 7 is connected in a structure that a socket is attached to an inner circumferential surface of the inner box 4, and a rod-shaped electric heater 7 is inserted.

At the electric heater 7, a punched hole mesh 6 is installed so as to prevent any ignition during heat treatment in a state that the wastes 54 comes into direct contact with the electric heater 7.

The punched hole mesh 6 comprises a plurality of punched holes which are formed except for the portions where the discharge door 9 is installed in the front surface, back surface, left surface and right surface where the electric heater 7 is installed. The punched hole mesh 6 is configured to emit heat toward the wastes 54 and prevent the wastes 54 from coming into close contact with the electric heater 7, thus emitting only the heat to the wastes 54.

At a bottom surface of the inner box 4, there is provided a waste distributor 11 configured in order for the wastes 54 inputted through the supply door 8 to be uniformly heaped from an edge portion of the inner box 4.

The waste distributor 11 is characterized in that a rotation motor 17 is installed at a lower bottom of the outer box 3, and a driving shaft 16 of the rotation motor 17 and a lower end are tightened along threads, and an upper end is configured in such a way that a shaft 18 protruding into the interior of the inner box 4 is engaged to a lower surface of a distribution cover 12.

The support pillar 19 installed at an outer circumferential surface of the shaft 18 protruding into the inner box 4 is characterized in that an inner tube 20 is vertically installed at a bottom of the inner box 4, and an outer tube 20′ with holes punched all over the surfaces is covered on an outer circumferential surface of the inner tube 20 so as to discharge heat to the outside, and to the upper surfaces of the inner tube 20 and the outer tube 20′, a roller cover 13 is engaged, wherein the roller cover 13 includes a roller groove part 22 for the roller 15 to roll.

A rod-shaped electric heater 7 is arranged at a regular interval between the inner and outer tubes 20 and 20′ along its surrounding and is electrically connected.

The distribution cover 12 engaged to the upper portion and lower surface of the shaft 18 and configured to rotate comprises a plurality of integrated rotation protrusions 27 which protrude in embossed shapes from the surfaces in a dome shape, thus increasing friction force during rotations and obtaining easier agitations, while improving heat efficiency by increasing grate area. A support rack 14 is provided inside so as to absorb the impacts of the wastes 54 for thereby improving durability. A plurality of rollers 15 are attached to a lower surface and are inserted into the roller groove part 22 formed in the roller cover 13 and roll along the roller groove part 22 and support the weight of the wastes 54.

The waste distributor 11 is configured to guide the wastes 54, which fall into the interior of the inner box 4, to collide with the distribution cover 12 and to heap first at an edge portion of the inner box 4 and allow the distribution cover 12 to rotate a predetermined time period during the heat treatment of the inputted wastes 54 and to be agitated, thus improving heat treatment efficiency.

A pair of vertical frames 25 are installed opposite to each other at one side of an outer circumferential surface of the outer box 3 so as to easily perform the opening and closing operations of the supply door 8. A rotary shaft 57 wherein the pulling motor 24 is installed is horizontally installed between the vertical frames 25. A wire 26 is wound on the rotary shaft 57 of the pulling motor 24, so the wire 26 may be wound or unwound so as to open or close in a state that the upper surface of the supply door 8 is connected to an end of the wire 26.

In the heat treatment unit 55, there is provided a filter unit 2 configured to filter noxious substances through first and second processes contained in the heat discharged into the filter unit 2 and produced when heat-treating the wastes 54 as the electric heater 7 is heated at a low temperature in a vacuum state, more specifically, in a state that air is not inputted in the interior.

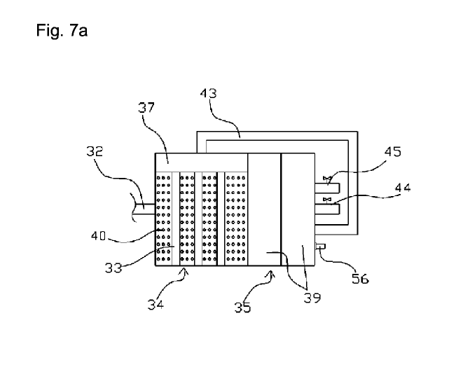

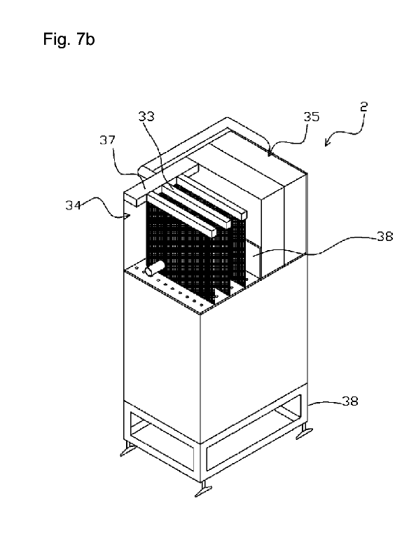

As illustrated in FIGS. 7A and 7B, the interior of the filter unit 2 is divided into a front surface and a back surface about a partition 38 which is vertically upright with a predetermined height high enough to filter the heat supplied into the interior of the box to which an end of one side of the heat discharge pipe 32 connected to the heat treatment unit 55 is connected. There is provided a water membrane filter part 34 is provided at a front surface of the partition 38 so as to purify and filter the noxious substances contained in the heat using water 59, wherein water flows from top to bottom in the water membrane filter part 34.

A vapor filtration filter part 35 is provided at a back surface of the partition 38 so as to filter vapor using a vapor filter 39, so noxious tar may be purified by means of water in the water membrane filter part 34, and the vapor produced during a purification procedure is second filtered by means of the vapor filter 39 and is discharged to a water tank 11.

The partition 38 maintains a predetermined height and a state wherein part of the partition 38 is open, thus guiding the vapor to easily flow into the vapor filtration filter part 35, while preventing water from flowing inside.

At the lower sides of the water membrane filter part 34 and the vapor filtration filter part 35, there is provided a water tank 11 so as to collect water produced when filtering and discharging the noxious tar 60 and vapor purified by means of water because a plurality of discharge holes 40 are formed on its bottom.

At top of the interior of the water tank 11, there is provided a tar discharge tube 45 so as to supply water and discharge the tar 60. At a bottom of the water tank, there is installed an underwater pump 42. There is also provided a cooling water supply tube 43 configured to circulate water into the water membrane filter part 34, and there is formed a water discharge tube 44 configured to discharge water.

In the winter, a heater adjusting set 56 is installed so as to heat the water in the water tank 41 and keep the temperature of the water at a predetermined level so that the water is not frozen.

In the heater adjusting set 56, there is provided a set of a heater and an adjuster which is configured to adjust temperature.

In the water membrane filter part 34, there are provided in an integrated structure a water distributor 37 configured to distribute water supplied through the cooling water supply tube 43 connected to the water tank 41 so as to form water membrane in such a way to allow water to continuously fall from top to bottom, and a plurality of water spray boxes 33 which are arranged at regular intervals in a longitudinal direction so as to spray water distributed by the water distributor 37 through spray nozzles, so that water falls from top to down.

A plate-shaped wire mesh 36 is vertically attached in a longitudinal direction to the spray nozzles of the water spray box 33, so water may fall at a low speed along the wire mesh 36.

A plurality of the water spray boxes 33 to each of which the wire mesh 36 is attached are arranged in a row. When heat passes step by step, the tar 60 contained in the heat is purified by water and is discharged into the water tank 41 together with water.

The tar 60 discharged into the water tank 41 has a viscosity different from that of water, so it separates from water and floats on top of the water, and the water beneath the tar 60 circulates into the water distributor 37.

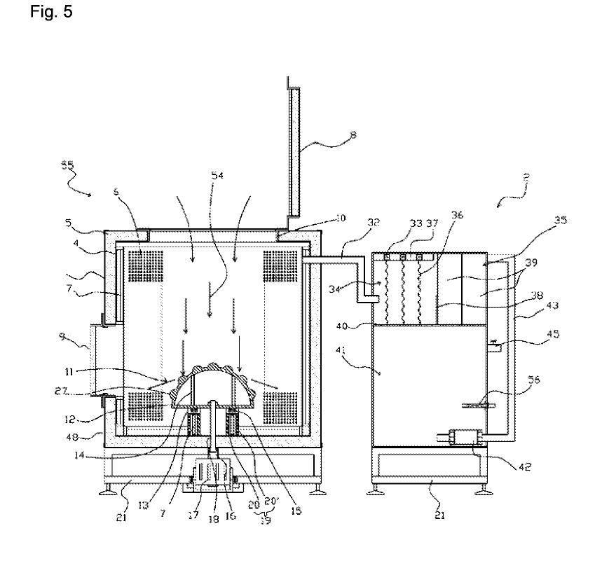

FIG. 5 is a cross sectional view illustrating an engaged state so as to explain an operation state of the waste distributor of an apparatus for heat-treating waste matters according to the present invention.

As not illustrated in the drawings, the waste heat treatment apparatus 1 according to the present invention is characterized in that when industrial wastes are inputted and fall through a conveyor into the interior of the inner box 4, the wastes collide with the distribution cover 12 of the waste distributor 11 and are heaped in order at an edge of the inner box 4. When the wastes 54 are full, the supply door 8 is closed, and the interior becomes a vacuum state in which external air is not filled. The electric heater 7 installed in the inner box 4 and the electric heater 7 installed at the waste distributor 11 are heated by means of an operation of the controller 48, so the wastes 54 are heated at a low temperature to the extent that the wasters 54 are not ignited.

The air supplied when the wastes 54 are supplied is all consumed in the interior of the inner box 4 when electric heater is heated, and when heating in a vacuum state at a low temperature, the wastes 54 block in order for the waster 54 not to come into direct contact with the electric heater 7, so the wastes 54 do not ignited but start to melt, and the molecules of oxygen, hydrogen, nitrogen, etc. evade, so the weight decreases, and only carbons 61 remain, whereby the volume may be reduced.

In the present invention, the grate area increases thanks to the heating of the electric heater 7 of the waste distributor 11 and the rotation protrusion 27, so the wastes may be heated concurrently inside and outside for thereby reducing heat treatment time.

When the volume of the wastes 54 decreases, and a predetermined space is formed in the interior of the inner box 4, the distribution cover 12 of the waste distributor 11 is rotated for a predetermined time period upon the rotation of the rotation motor 17, so the wastes 54 may be agitated, thus causing faster heat treatment.

The rotation protrusion 27 formed at the distribution cover 12 helps expand the grate area, while increasing a friction force with respect to the wastes during the rotation of the distribution cover 12, thus easily performing agitations.

The heat produced when the heat treatment unit 55 heat-treats the wastes 54 is discharged through the heat discharge tube 32 to the filter unit 2. When it passes through the wire mesh 36 of the water membrane filter part 34, the noxious substances contained in the tar 60 are purified by means of water and are discharged through the discharge holes 40 into the water tank 41. The vapor produced when the heat and water come into contact with each other is supplied to the vapor filtration filter part 35, and the noxious substances remaining in the vapor is second purified by means of the vapor filter 39, and the water produced as the vapor is cooled during the filtration procedure is discharged through the discharge holes 40 into the water tank 41, so noxious substance containing the tar 60 is not discharged to the outside, thus obtaining ecological operations.

The vapor filter 39 of the vapor filtration filter part 35 consists of two portions: one portion configured to filter malodor and the other portion configured to filter in order the noxious substances.

When the tar 60 discharged into the interior of the water tank 41 floats on water and separates from the water, the tar 60 remains, and only the water circulates through the cooling water supply tube 43 into the water distributor 37 by means of the underwater pump 42.

When the cooling procedure is performed after the waste heat treatment procedure is finished by the heat treatment unit 55, only the carbon 61 may remain in the inner box 4, and the remaining carbons are collected and used as industrial materials, and only the tar 60 remaining in the water tank 41 is discharged through the tar discharge tube 45.

Since the water level is lower than the tar 60, the water is not discharged, and only the tar 60 is discharged. Here, the water is discharged through the water discharge tube 44 disposed at a lower side of the water tank 41, and the water is supplied through the tar discharge tube 45 into the interior of the water tank 41.

The present invention is ecological because noxious gas such as carbon dioxide and dioxin produced when extracting carbons 61 by heat-treating the wastes 54 and micro size dusts are first purified using water and are second purified using the vapor filter 39 and are discharged into the water tank 41, so noxious substances are not discharged to the outside.

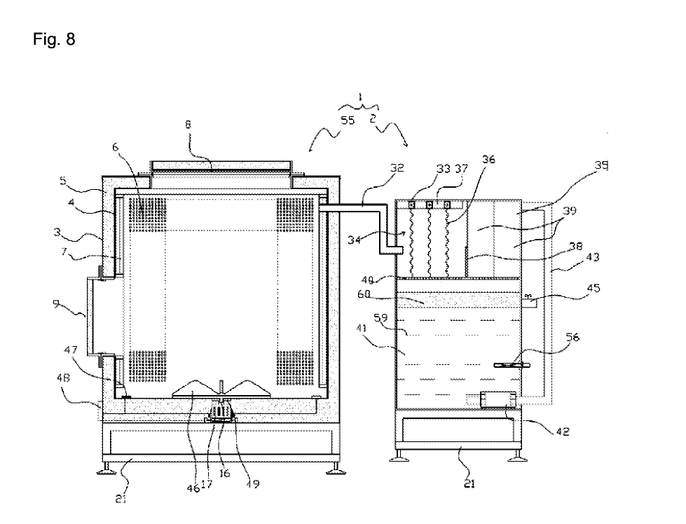

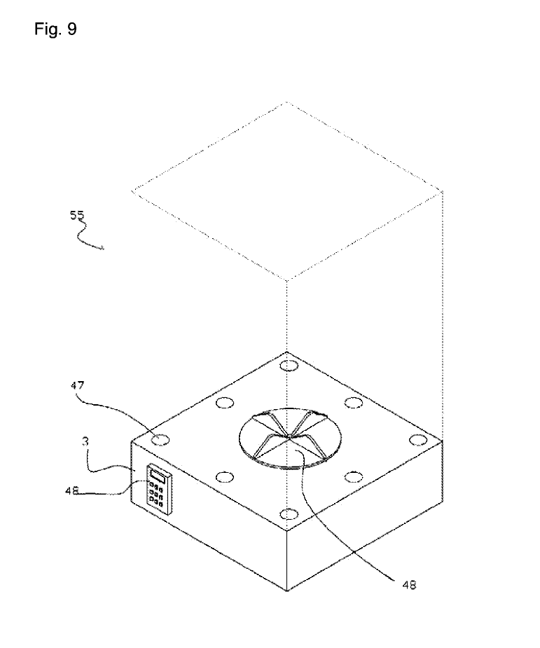

FIG. 8 is a cross sectional view illustrating an apparatus for heat-treating waste matters according to another exemplary embodiment of the present invention. FIG. 9 is an enlarged perspective view schematically illustrating an apparatus for heat-treating waste matters according to another exemplary embodiment of the present invention.

The heat treatment unit 55 according to the present invention is characterized in that the waste distributor 11 is not installed in the inner box 4. It may be configured to shorten a heat treatment time by improving heat treatment efficiency in such a way that the wastes 54 are agitated when the weight of the wastes 54 reaches a predetermined weight during the heat treatment.

Meanwhile, it needs to agitate the wastes 54 during the heat treatment of the wastes 54 for the reasons that when the wastes are melted at a low temperature and are heaped on the inside wastes 54, the heat treatment of the wastes 54 may be prolonged. So, the wastes are agitated, thus shortening heat treatment time.

In the present invention, there are provided a plurality of weight detection sensors 47 configured to detect the weight of the wastes on the bottom surface of the inner fox 4 and transmit a signal corresponding to the detected weight to the controller 48. The weight detection sensors 47 are connected to the controller 48.

On the bottom surface of the inner box 4, there are provided a plate-shaped distribution screw 46 which is made from an insulation and fire-proof material in a circular plate shape and is vertically upright as it is arranged in a cross shape on its upper surface, and a distribution screw 46 which is tightened and engaged to and rotates together with the driving shaft of the rotation motor 17 positioned at the insulation material layer 5 in a state that on the center of the lower surface of the distribution crew 46, the downwardly protruding shaft is inserted in the insulation material layer 5 of the inner box 4.

The rotation motor 17 is connected through a lead wire to the controller 48. When the wastes reaches a previously set weight, the weight detection sensor 47 detects such a weight, and the distribution screw 46 operates for a predetermined set time period, and the wastes 54 are agitated.

A dust input prevention shoulder 49 is integrally formed around the driving shaft which is tightened and engaged to the shaft of the distribution screw 46 inserted in the insulation material layer 5, thus preventing the dusts from falling in the rotation motor 17 and the heat from directly emitting to the rotation motor 17.

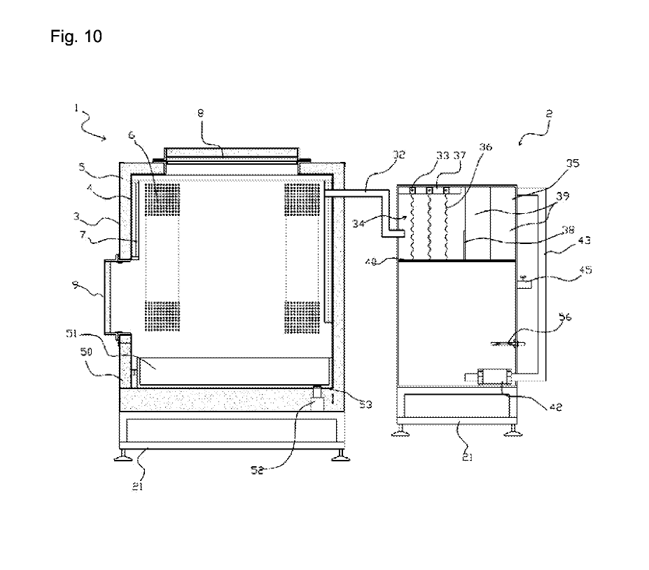

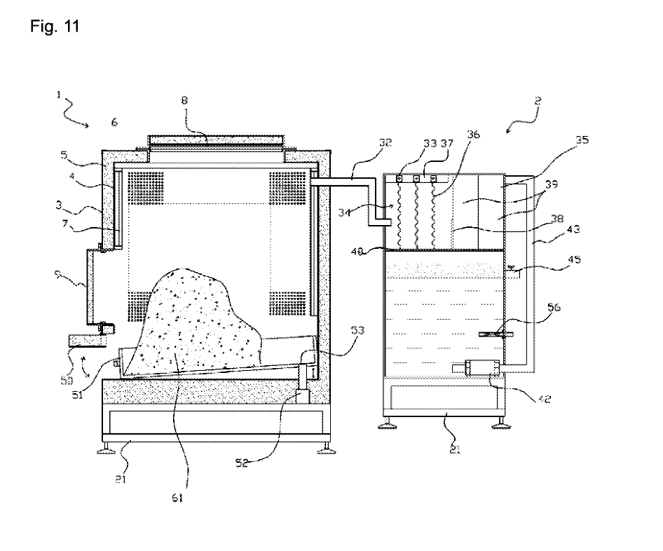

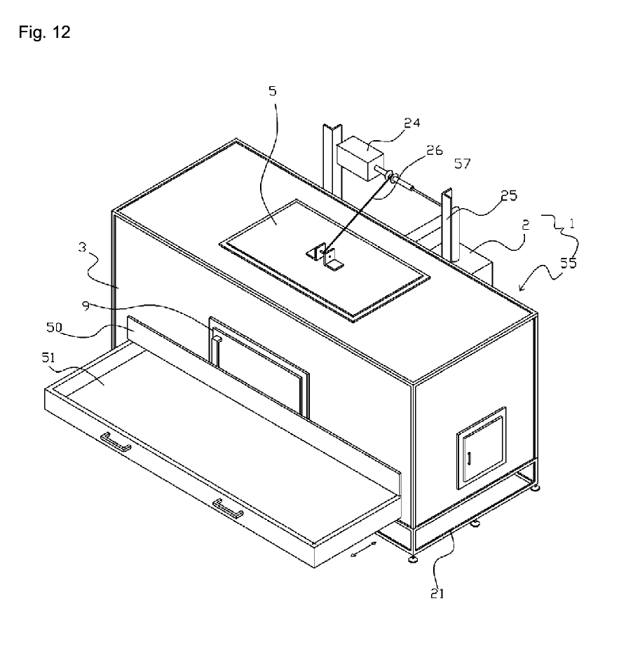

FIG. 10 is a cross sectional view illustrating an apparatus for heat-treating waste matters according to another exemplary embodiment of the present invention. FIG. 11 is a cross sectional view illustrating an operation state of an apparatus for heat-treating waste matters of FIG. 10. FIG. 12 is a perspective view illustrating an apparatus for heat-treating waste matters of FIG. 10.

The heat treatment apparatus according to the present invention is characterized in that in order to easily discharge to the outside the carbons 61 remaining after heat treatment by the electric heater 7, a drawer door 50 is installed at a lower side of the discharge door 9 positioned at a front surface of the outer box 3 for the sake of a rotatable opening and closing based on a hinged structure.

In the bottom of the inner box 4, a height adjusting insertion groove 53 is formed inwardly at an end of one side of the bottom surface so as to discharge the wastes 54 in such a way that it is withdrawn or slid in like a drawer through the drawer door 50, so the drawer 51 is inserted in order for an end of the piston rod of the cylinder 52 to engage or disengage.

A cylinder 52 is installed in the insulation material layer 5 so that the wastes 54 guide the melted carbons 61 to slid in the door direction of the drawer 51 in such a way that the height adjusting insertion groove 53 formed at an end of the bottom surface of the drawer 51 has a predetermined angle slanted by upwardly pushing the rear end of the drawer 51 since it is engaged to or disengaged from an end of the piston rod based on the ascending of the piston rod. The cylinder 52 is connected through a lead wire to the controller 48.

The heat treatment unit 55 is characterized in that part of the carbons 61 remaining after the heat treatment, the filtering procedure and the cooling procedure are performed is discharged by opening the discharge door 9 so as to discharge the remaining carbons in a state that the wastes 54 are heaped in the drawer 51 inserted in the interior of the inner box 4. The piston rod of the cylinder 52 ascends in response to a control of the controller 48 and is inserted in the height adjusting insertion groove 53, thus ascending an end of the drawer 51. The carbons 61 are collected in the direction of the discharge door 9, so the discharge process may be easily performed. After the piston rod of the cylinder 52 descends and returns back to its initial position, the end of the piston rod is disengaged from the height adjusting insertion groove 53, and the drawer door 50 is opened, and the handle attached to the drawer 51 is pulled out, so part of the drawer 51 is withdrawn, thus discharging the remaining carbons 61, and the carbons 61 remaining on the bottom are cleaned and removed, so the work time of the discharge work and the work environment of workers may be improved.

1. An apparatus for heat-treating waste matters, comprising:
an outer box 3 which is configured to input wastes 54 into its interior and heat-treat the wastes 54 at a low temperature under a vacuum environment in a state that a prop 21 is installed at bottom and includes on its upper surface a supply door 8 configured to input wastes, a discharge door 9 installed on its front surface and side surface and configured to discharge the wastes decomposed into carbon states, and a controller 48 installed on its outer circumferential surface and configured to control an electric heater 7 and a waste distributor 11;
an insulation material layer 5 which is installed in the interior of the outer box 3 and is configured to seal the portions using an insulation material except for the supply door 8 and the discharge door 9;
an inner box 4 which is disposed inside the insulation material layer 5 and is configured to supply wastes through the supply door 8 and the discharge door 9 into the interior, which are made from a stainless material so as to prevent corrosion, and discharge the decomposed wastes, wherein a heat discharge tube 32 is externally provided so as to supply into a filter unit 2 the head produced when heat-treating the wastes;
an electric heater 7 which is formed in a rod shape and is disposed at a front surface, a back surface, a left surface and a right surface in the inner circumferential surfaces of the inner box 4 except for the portions where the discharge door 9 is installed, and which is arranged at a regular interval and is configured to heat-treat the wastes in a state that the electric heater 7 is electrically connected;
a punched hole mesh 6 which is disposed in a front surface, a back surface, a left surface and a right surface wherein the electric heater 7 is installed except for the portions where the discharge door 9 is installed and which is formed of a plurality of holes to emit heat to the wastes and prevent the wastes from coming into contact with the electric heater 7;
a heat treatment unit 55 which is disposed at a bottom surface of the inner box 4 and includes a waste distributor 11 which protrudes and performs distribution in order for the wastes inputted through the supply door 8 to collide and be uniformly collected in the interior from an edge of the inner box 4;
a water membrane filer part 34 wherein water 59 flows on its front surface from top to bottom in order for noxious substances contained in the heat to be purified by water, in such a way that the interior of the same is divided into a front surface and a back surface about a partition 38 which is vertically upright so as to filter the heat supplied into the interior of a box body connected through a heat discharge tube 32 to the heat treatment unit 55;
a vapor filtration filter part 35 which is disposed at a back surface of the partition 38 and is configured to filter, using a vapor filter 38, malodor and noxious substances from the vapor filtered by the water membrane filter part 34 and discharge into a water tank 41;
a water tank 41 which is disposed at a lower side so as to collect a tar 60 and water 59 purified by the water 59 wherein a plurality of discharge holes 40 are formed at the bottoms of the water membrane filter part 34 and the vapor filtration filter part 35; and
a filter unit 2 which includes a tar discharge tube 45 disposed at top of one side in the interior of the water tank 41 and configured to discharge the collected tar 60 to the outside, a water discharge tube 44 disposed at a lower side of the water tank 41 and configured to discharge water, a cooling water supply tube 43 configured to circulate and supply water into the water membrane filter part 34 wherein an underwater pump 42 is installed in the interior of the water tank 41, and a heater adjusting set 56 wherein a heater and a temperature adjusting unit are integrally formed in order for the water stored in the interior of the water tank 41 not to be frozen.

2. The apparatus of claim 1, wherein the waste distributor 11 comprises:
a rotation motor 17 which is installed at bottom of the outer box 3;
a shaft 18 whose a lower end is tightened and engaged along threads to a driving shaft 16 of the rotation motor 17, wherein its upper end protrudes into the interior of the inner box 4 and is engaged to a bottom surface of a distribution cover 12;
a support pillar 19 which includes an inner tube 20 inserted into an outer circumferential surface of the shaft 18 protruding into the inner box 4 and installed in a vertical direction at bottom of the inner box 4 and an outer tube 20′ covers an outer circumferential surface of the inner tube 20 wherein punched holes are formed on the whole surfaces so as to discharge heat to the outside, and a roller cover 13 is engaged to the support pillar 19 wherein a roller groove part 22 is formed on the upper surfaces of the inner tube 20 and the outer tube 20′ in order for a roller 15 to roll;
a rod-shaped electric heater 7 which is disposed between the inner and outer tubes 20 and 20′ and is arranged at a regular interval and is electrically connected; and
the distribution cover 12 which is configured to support the rotation and the weight of the wastes in such a way that a plurality of rollers 15 are attached to a lower surface and are inserted in the roller groove part 22 in a state that it is engaged to top of the shaft 18, wherein on its top, there are provided a plurality of rotation protrusions 27 protruding in an embossed shape from the surfaces in a dome shape, so when the wastes are inputted into the interior of the inner box 4, the falling wastes 54 collide with the distribution cover 12 and are guided to first position at an edge, and the distribution cover 12 rotates during a heat treatment of the inputted wastes for thereby agitating the wastes.

3. The apparatus of claim 1, wherein a pair of facing vertical frames 25 are installed at one side of an outer circumferential surface of the outer box 3 so as to open or close the supply door 8, and a rotary shaft 57 wherein a pulling motor 24 is engaged is horizontally installed between the vertical frames 25, and a wire 26 is wound on the rotary shaft 57 of the puffing motor 24, so the opening and closing operation is performed by winding or unwinding the wire 26 in a state that an end of the wire 26 is engaged to the upper surface of the supply door 8.

4. An apparatus for heat-treating waste matters, comprising:
an outer box 3 which is configured to input wastes 54 into its interior and heat-treat the wastes 54 at a low temperature under a vacuum environment in a state that a prop 21 is installed at bottom and includes on its upper surface a supply door 8 configured to input wastes, a discharge door 9 installed on its front surface and side surface and configured to discharge the wastes decomposed into carbon 61 states, and a controller 48 installed on its outer circumferential surface and configured to control an electric heater 7, a weight detection sensor 47 and a rotation motor 17;
an insulation material layer 5 which is installed in the interior of the outer box 3 and is configured to seal the portions using an insulation material except for the supply door 8 and the discharge door 9;
an inner box 4 which is disposed inside the insulation material layer 5 and is configured to supply wastes 54 through the supply door 8 and the discharge door 9 into the interior, which are made from a stainless material so as to prevent corrosion, and discharge the decomposed wastes, wherein a heat discharge tube 32 is externally provided so as to supply into a filter unit 2 the head produced when heat-treating the wastes;
an electric heater 7 which is formed in a rod shape and is disposed at a front surface, a back surface, a left surface and a right surface in the inner circumferential surfaces of the inner box 4 except for the portions where the discharge door 9 is installed, and which is arranged at a regular interval and is configured to heat-treat the wastes in a state that the electric heater 7 is electrically connected;
a punched hole mesh 6 which is disposed in a front surface, a back surface, a left surface and a right surface wherein the electric heater 7 is installed except for the portions where the discharge door 9 is installed and which is formed of a plurality of holes to emit heat to the wastes and prevent the wastes from coming into contact with the electric heater 7;
a plurality of weight detection sensors 47 which are installed at a bottom surface of the inner box 4 so as to detect the weight of the waste and are configured to transmit a signal corresponding to the detected weight to the controller 48;
a distribution screw 46 wherein on the bottom surface of the inner box 4, there are provided a plate-shaped distribution screw 46 which is made from an insulation and fire-proof material in a circular plate shape and is vertically upright as it is arranged in a cross shape on its upper surface, and a distribution screw 46 which is tightened and engaged to and rotates together with the driving shaft 16 of the rotation motor 17 positioned in the inner box 4 as the shaft protruding downward from the center of the lower surface of the distribution screw 46 is inserted in the insulation material layer 5 of the inner box 4;
a heat treatment unit 55 characterized in that a rotation motor 17 around which a dust input prevention shoulder 49 is integrally formed is installed at the driving shaft 16 tightened and engaged to the shaft of the distribution screw 46 inserted in the insulation material layer 5, and when the weight of the wastes inputted in the inner box 4 reaches a predetermined weight previously inputted in the controller 48, the distribution screw 46 rotates for a predetermined time period for thereby agitating the wastes;
a water membrane filer part 34 wherein water flows on its front surface from top to bottom in order for noxious substances contained in the heat to be purified and filtered by water, in such a way that the interior of the same is divided into a front surface and a back surface about a partition 38 which is vertically upright so as to filter the heat supplied into the interior of a box body connected through a heat discharge tube 32 to the heat treatment unit 55;
a vapor filtration filter part 35 which is disposed at a back surface of the partition 38 and is configured to filter, using a vapor filter 38, malodor and noxious substances from the vapor filtered by the water membrane filter part 34 and discharge into a water tank 41;
a water tank 41 which is disposed at a lower side so as to collect a tar 60 and water 59 purified by the water 59 wherein a plurality of discharge holes 40 are formed at the bottoms of the water membrane filter part 34 and the vapor filtration filter part 35; and
a filter unit 2 which includes a tar discharge tube 45 disposed at top of one side in the interior of the water tank 41 and configured to discharge the collected tar 60 to the outside, a water discharge tube 44 disposed at a lower side of the water tank 41 and configured to discharge water, a cooling water supply tube 43 configured to circulate and supply water into the water membrane filter part 34 wherein an underwater pump 42 is installed in the interior of the water tank 41, and a heater adjusting set 56 wherein a heater and a temperature adjusting unit are integrally formed in order for the water stored in the interior of the water tank 41 not to be frozen.

5. An apparatus for heat-treating waste matters, comprising:
an outer box 3 which is configured to input wastes 54 into its interior and heat-treat the wastes 54 at a low temperature under a vacuum environment in a state that a prop 21 is installed at bottom and includes on its upper surface a supply door 8 configured to input wastes, a discharge door 9 installed on its front surface and side surface and configured to discharge the wastes decomposed into carbon states, and a controller 48 installed on its outer circumferential surface and configured to control an electric heater 7 and a cylinder;
an insulation material layer 5 which is installed in the interior of the outer box 3 and is configured to seal the portions using an insulation material except for the supply door 8 and the discharge door 9;
an inner box 4 which is disposed inside the insulation material layer 5 and is configured to supply wastes through the supply door 8 and the discharge door 9 into the interior, which are made from a stainless material so as to prevent corrosion, and discharge the decomposed wastes, wherein a heat discharge tube 32 is externally provided so as to supply into a filter unit 2 the head produced when heat-treating the wastes;
an electric heater 7 which is formed in a rod shape and is disposed at a front surface, a back surface, a left surface and a right surface in the inner circumferential surfaces of the inner box 4 except for the portions where the discharge door 9 is installed, and which is arranged at a regular interval and is configured to heat-treat the wastes in a state that the electric heater 7 is electrically connected;
a punched hole mesh 6 which is disposed in a front surface, a back surface, a left surface and a right surface wherein the electric heater 7 is installed except for the portions where the discharge door 9 is installed and which is formed of a plurality of holes to emit heat to the wastes and prevent the wastes from coming into contact with the electric heater 7;
a drawer door 50 which is disposed at a lower side of the discharge door 9 positioned at a front surface of the outer box 3 and is configured to rotatably open or close based on a hinged structure;
a drawer 51 which is disposed at a bottom of the inner box 4 and is configured to withdraw or slide in like a drawer through the drawer door 50 so as to discharge the wastes, wherein a height adjusting insertion groove 53 is formed at an end of one side of the bottom surface, and an end of the piston rod of the cylinder 52 is inserted;
a heat treatment unit 55 which includes a cylinder 52 installed in the insulation material layer 5 so that the heat-treated wastes 54 is guided to slide in the direction of the drawer door 50 in such a way that there is provided a predetermined angle at which to obliquely push the drawer 51 as the piston rod ascends when an end of the piston rod separates from or is engaged to the height adjusting insertion groove 53 formed at an end of the lower surface of the drawer 51;
a water membrane filer part 34 wherein water 59 flows on its front surface from top to bottom in order for noxious substances contained in the heat to be purified and filtered by water 59, in such a way that the interior of the same is divided into a front surface and a back surface about a partition 38 which is vertically upright so as to filter the heat supplied into the interior of a box body connected through a heat discharge tube 32 to the heat treatment unit 55;
a vapor filtration filter part 35 which is disposed at a back surface of the partition 38 and is configured to filter, using a vapor filter 38, malodor and noxious substances from the vapor filtered by the water membrane filter part 34 and discharge into a water tank 41;
a water tank 41 which is disposed at a lower side so as to collect a tar and water purified by the water wherein a plurality of discharge holes 40 are formed at the bottoms of the water membrane filter part 34 and the vapor filtration filter part 35; and
a filter unit which includes a tar discharge tube 45 disposed at top of one side in the interior of the water tank 41 and configured to discharge the collected tar 60 to the outside, a water discharge tube 44 disposed at a lower side of the water tank 41 and configured to discharge water, a cooling water supply tube 43 configured to circulate and supply water into the water membrane filter part 34 wherein an underwater pump 42 is installed in the interior of the water tank 41, and a heater adjusting set 56 wherein a heater and a temperature adjusting unit are integrally formed in order for the water stored in the interior of the water tank 41 not to be frozen.

6. The apparatus of claim 1, wherein the supply door 8 and the discharge door 9 are formed of a supply door, a discharge door and a door frame 10, and a gasket is disposed between them, and the door frame 10 is fixedly inserted in the outer box 3 wherein the supply door 8 and the discharge door 9 are installed so as to protect the gasket 23 from heat, and an outer frame 29 is provided around the inner circumferential surface of the door frame 10 and is made from a fireproof material and includes an insertion protrusion 31 inserted in the insertion groove 30, and an inner frame 28 made from a fireproof material wherein an insertion groove 30 is integrally formed to correspond to the insertion protrusion 31 is attached to around the inner circumferential surfaces of the supply door 8 and the discharge door 9 so that the insertion protrusion 31 may be inserted when the supply door 8 and the discharge door 9 are closed, so the insertion protrusion 31 is inserted or separates, thus preventing heat from conducting to the gasket 23.

7. The apparatus of claim 1, wherein the water membrane filter part 34 of the filter unit 2 comprises:
a water distributor 37 configured to distribute water supplied through the cooling water supply tube 43;
a plurality of water spraying boxes 33 which are disposed at a lower surface in a longitudinal direction so as to spray the water distributed and supplied from the water distributor and include spray nozzles arranged at regular intervals for water to fall downward; and
a plate shaped wire mesh 36 which is attached in a longitudinal direction to the spray nozzles of the water spraying boxes 33 in order for the water to flow along the wire mesh 36.

8. The apparatus of claim 1, wherein a pair of facing vertical frames 25 are installed at one side of an outer circumferential surface of the outer box 3 so as to open or close the supply door 8, and a rotary shaft 57 wherein a pulling motor 24 is engaged is horizontally installed between the vertical frames 25, and a wire 26 is wound on the rotary shaft 57 of the pulling motor 24, so the opening and closing operation is performed by winding or unwinding the wire 26 in a state that an end of the wire 26 is engaged to the upper surface of the supply door 8.

9. The apparatus of claim 4, wherein the supply door 8 and the discharge door 9 are formed of a supply door, a discharge door and a door frame 10, and a gasket is disposed between them, and the door frame 10 is fixedly inserted in the outer box 3 wherein the supply door 8 and the discharge door 9 are installed so as to protect the gasket 23 from heat, and an outer frame 29 is provided around the inner circumferential surface of the door frame 10 and is made from a fireproof material and includes an insertion protrusion 31 inserted in the insertion groove 30, and an inner frame 28 made from a fireproof material wherein an insertion groove 30 is integrally formed to correspond to the insertion protrusion 31 is attached to around the inner circumferential surfaces of the supply door 8 and the discharge door 9 so that the insertion protrusion 31 may be inserted when the supply door 8 and the discharge door 9 are closed, so the insertion protrusion 31 is inserted or separates, thus preventing heat from conducting to the gasket 23.

10. The apparatus of claim 5, wherein the supply door 8 and the discharge door 9 are formed of a supply door, a discharge door and a door frame 10, and a gasket is disposed between them, and the door frame 10 is fixedly inserted in the outer box 3 wherein the supply door 8 and the discharge door 9 are installed so as to protect the gasket 23 from heat, and an outer frame 29 is provided around the inner circumferential surface of the door frame 10 and is made from a fireproof material and includes an insertion protrusion 31 inserted in the insertion groove 30, and an inner frame 28 made from a fireproof material wherein an insertion groove 30 is integrally formed to correspond to the insertion protrusion 31 is attached to around the inner circumferential surfaces of the supply door 8 and the discharge door 9 so that the insertion protrusion 31 may be inserted when the supply door 8 and the discharge door 9 are closed, so the insertion protrusion 31 is inserted or separates, thus preventing heat from conducting to the gasket 23.

11. The apparatus of claim 4, wherein the water membrane filter part 34 of the filter unit 2 comprises:
a water distributor 37 configured to distribute water supplied through the cooling water supply tube 43;
a plurality of water spraying boxes 33 which are disposed at a lower surface in a longitudinal direction so as to spray the water distributed and supplied from the water distributor and include spray nozzles arranged at regular intervals for water to fall downward; and
a plate shaped wire mesh 36 which is attached in a longitudinal direction to the spray nozzles of the water spraying boxes 33 in order for the water to flow along the wire mesh 36.

12. The apparatus of claim 5, wherein the water membrane filter part 34 of the filter unit 2 comprises:
a water distributor 37 configured to distribute water supplied through the cooling water supply tube 43;
a plurality of water spraying boxes 33 which are disposed at a lower surface in a longitudinal direction so as to spray the water distributed and supplied from the water distributor and include spray nozzles arranged at regular intervals for water to fall downward; and
a plate shaped wire mesh 36 which is attached in a longitudinal direction to the spray nozzles of the water spraying boxes 33 in order for the water to flow along the wire mesh 36.
